(19) United States
(12) Patent Application Publication
(10) Pub. No.: US 2002/0168525 A1
(43) Pub. Date: Nov. 14, 2002

(54) Carbon nanotube RLC circuits

(76) Inventors: Sung-Hwan Han, Seoul (KR); Oh-Shim Joo, Seoul (KR); Kwang-Deog Jung, Seoul (KR)

Correspondence Address: FITZPATRICK CELLA HARPER & SCINTO, 30 ROCKEFELLER PLAZA, NEW YORK, NY, 10112, US

(21) Appl. No.: 09/918,460

(22) Filed: Aug. 1, 2001

(30) Foreign Application Priority Data
Mar. 15, 2001 (KR) 2001-13481

(51) Int. Cl. B32B 9/00

(52) U.S. Cl. 428/408

(57) ABSTRACT

The present invention relates to carbon nanotube Resistance Inductance Capacitance (hereinafter referred as to “RLC”) circuits. More particularly, the present invention is to provide the carbon nanotube prepared by chemical vapor deposition (hereinafter referred as to “CVD”) on a surface of inorganic substrate to have advantages in: (i) its use for resistance, inductance and capacitance elements, (ii) the formation of micro circuits loaded with RLC characters and different inductor from the inductor used ferrite core and coil, (iii) heat resistance and impact resistance because it is made of carbon/inorganic composite materials, and (iv) the formation of nanotubes unlike conventional chip inductor.

### BACKGROUND OF THE INVENTION

Field of the Invention

The present invention relates to carbon nanotube Resistance Inductance Capacitance (hereinafter referred as to “RLC”) circuits. More particularly, the present invention is to provide the carbon nanotube and nanostructures (such as carbon nanofiber, graphitic carbon, and amorphous carbon. hereinafter referred as to “carbon nanotubes” in general) prepared by chemical vapor deposition (hereinafter referred as to “CVD”) of hydrocarbons on a surface of inorganic substrate to have advantages in: (i) its use for resistance, inductance and capacitance elements, (ii) the formation of microcircuits loaded with RLC characters which have different inductor from the inductor used ferrite core and coil, (iii) heat resistance and impact resistance because it is made of carbon/inorganic composite materials, and (iv) the formation of nanotubes unlike conventional chip inductor. While the conventional circuits have two-dimensional linear-linkage of separate capacitors, inductors, and resistors, the carbon nanotubes have the mixed properties of a resistor, a capacitor and an inductor in a single bead or on a flat surface to be designed as RLC circuits and thus, they can be widely applied in the field of communication circuits, semiconductor circuits and the like with the purpose of increasing integration and reducing size as well as physical and chemical stabilities.

It has been known that there is a drawback to control both inductance and capacitance in the formation of RLC circuits. With conventional technology to obtain RLC circuits, capacitors can be obtained in integrated circuits by utilizing the transition capacitance of a reverse-biased p-n junction or a thin film technique.

However, no practical inductance values have been obtained on silicon semiconductor substrates. Conventional technology known to generate inductance is a chip inductor by winding a coil artificially around a ferrite core. However, the use of inductors is avoided in circuit designs wherever possible, because the product prepared through this technology has a minimum mm size. Thus, it is difficult to reduce the size of electronic circuits and parts. Therefore, it is highly demanded to develop new technologies to solve such problems.

The conventional circuits have two-dimensional linear-linkage of separate capacitors, inductors, and resistors. If the circuits can be arranged in three-dimension, the size can be prevented from increasing. For this purpose, the circuits are built within a printed circuit boards by forming layers. But this method to layering printed circuit boards requires printed boards between layers, so that it is limited to reduce the size along with increasing integration.

### SUMMARY OF THE INVENTION

To solve aforementioned problems of the conventional method to build circuits, the inventors have intensively studied to prepare electronic circuits having a mixed properties of a resistor, a capacitor, and an inductor since the inventors have expected to design novel circuits, if RLC circuits are arranged three-dimensionally. As a result, the present invention was completed by forming carbon nanotubes on the surface of an inorganic substrate, which provide a mixed properties of a resistor, a capacitor, and an inductor in a single bead with a three-dimensional structure as well as on a two-dimensional surface, and can be designed of a series of electronic functions such as RL, RC and RLC circuits with highly improved integration because the characteristics of the carbon nanotube microcircuits can be designed properly.

Consequently, an object of the present invention is to provide novel microcircuits having RLC electronic function by building carbon nanotubes and carbon nanostructures through chemical vapor deposition (CVD) and arranging them two-dimensionallv and three-dimensionally.

### BRIEF DESCRIPTION OF THE INVENTION

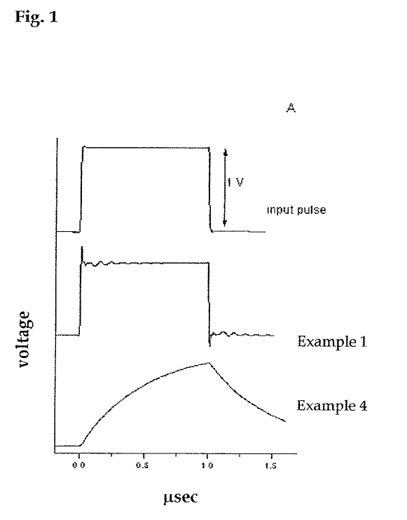

FIG. 1 represents voltages in the output after applying a single pulse to RLC circuits prepared in Examples 1 and 4 of the present invention.

### DETAILED DESCRIPTION OF THE INVENTION

The present invention is characterized by the carbon nanotube RLC circuits designed by optimizing chemical vapor deposition of carbon on the surface of inorganic substrates.

Another carbon nanotubes having different characteristic can be formed two-dimensionally on the surface of the carbon nanotube prepared by the CVD and further multi layers having another characteristic can be formed three-dimensionally on the surface of the two-dimensionally prepared carbon nanotubes, thus resulting in RLC circuits on the substrates with remarkably reduced size.

The present invention is described in detail as set forth hereunder.

The present invention relates to the carbon nanotube microcircuits on the surface of the inorganic substrates having the mixed properties of a resistor, a capacitor, and an inductor, and the formation of two dimensional or three-dimensional RLC circuits using thereof where the size can be prevented from increasing along with increasing integration. Such RLC circuits can be widely useful in the field of communication circuits, semiconductor circuits and the like.

The carbon nanotube RLC circuits of the present invention are described more particularly hereunder.

The carbon nanotube microcircuits of the present invention can be obtained by chemical vapor deposition of hydrocarbons on an inorganic substrate placed in a reactor, wherein the chemical vapor deposition is carried with heat or plasma and hydrocarbons are decomposed under inert or reducing atmosphere such as hydrogen atmosphere.

The inorganic substrate can be any kind which is stable at an elevated temperature and examples are alumina, silica, aluminosilicate, laminated compound, zeolite, mesophorous compound, yttrium stabilized zirconia, zirconia, Fe₂O₃, Mn₂O₃, TiO₂, NbₙOₓ, carbon and the like. Such inorganic substrate can be used alone or as a mixture of two or more, if necessary. The preparation of the inorganic substrate affects the character of carbon nanotubes because these inorganic substrates can contain metal ions depending on the preparation methods. The chemical vapor deposition of carbons on the surface of the inorganic substrate is carried at acid center and metal state. So, if the inorganic substrate has an acid center, it is enough to deposit carbons or impregnate metal on the surface thereof, if desired. Examples of metal are Ni, Fe, Co, Cu, Mn, Cr, Mo, W, Ru, Rh, Pd, Pt and the like and these metals can be used alone or as a mixture of two or more. However, the metal is not limited to any particular one. Besides these metals, carbon can be also impregnated. An amount of the metal is not limited but lower amount is better in the formation of uniform metal layer on the surface. On the other hand, higher amount provides less change of the characteristic of the RLC circuits which is only affected by a kind of metal used. That is, the amount of metal used is not limited but it can be decided depending on the character of the RLC circuit.

The carbon used in the chemical vapor deposition is C₁-C₂₄ hydrocarbon. The kind of hydrocarbons affects on electronic function of the carbon nanotube microcircuits. The hydrocarbon used in the present invention can be any one which is capable of being vaporized and examples are methane, ethane, ethylene, acetylene, propane, propylene, methylacetylene, butane, butene, isobutylene, benzene, toluene, naphthalene and the like. These hydrocarbons can be used alone or as a mixture of two or more, if desired.

The carbon nanotubes can be doped chemically with various materials which contain P, B, N, S, Al, or Ga used as a dopant of silicon. When the carbon nanotubes are doped with such a dopant, the electronic property of the carbon nanotubes can be changed. The dopant can be used alone or as a mixture for two or more if desired.

Electronic properties of the carbon nanotubes directly depends on the chemical vapor deposition temperature. Amorphous carbon nanotubes are formed at a temperature of 300-800° C. and high crystalline graphitic carbon nanotubes are formed at a higher temperature than 800° C. The low temperature chemical vapor deposition produces carbon nanotubes with a good capacitance and the high temperature vapor deposition does with a good inductance. Especially, when the chemical vapor deposition is performed at the high temperature, recrystallization of inorganic materials and carbon structure around thereof depend on the kind of inorgnanic substrates used. Therefore, an appropriate control of the chemical vapor deposition temperature, which is a key factor to build an inductance, allows to control carbon structure and further the electronic properties of the RLC circuits.

Hereunder is given a more detailed description of the present invention. However it should not be construed as limiting the scope of the present invention.

### EXAMPLE 1

### Use of Methane as Hydrocarbon

γ-Alumina was sensitized in Ni dissolved in water or an organic solvent and calcined at 900° C. γ-Alumina bead with ⅛ in.×⅛ in. was placed in a quartz reactor and a mixture of methane and hydrogen (1:1) was introduced thereto. Carbon was deposited at 1,000° C. by heating the reactor with a heater. After depositing for 6 hrs, electronic properties were monitored. The voltage in the output after applying a single pulse was recorded as in FIG. 1 to represent the characteristic inductive effect. The appearance of the damping waves represented the same inductive character that the conventional ferrite coil did. This confirmed that the formation of inductive character in a single bead of carbon nanotube/alumina.

### EXAMPLES 2-6

### Use of Methane as Hydrocarbon

Carbon was deposited on the surface of alumina by the chemical vapor deposition according to Example 1 except applying different time for the chemical vapor deposition to control the ratio of carbon and inorganic substrate. The resistance, inductance and capacitance measurements were performed at a frequency of 10 MHz with RLC meter and impedance analyzer.

The result indicated that the inductance decreased and the capacitance increased as the carbon content on the surface of alumina decreased. At the initial state of carbonization, high resistance was observed with high capacitance because the grain boundaries of carbon were not connected each other. For increasing carbonization time from 1 to 2 hr (Examples 3 & 4) , the resistance decreased from 1.4×10⁴ to 10 ohm along with the decrease in capacitance as shown in Table 1. At this point inductance was generated and it rapidly increased with the increase in carbonization time. The increase in inductance with the increase in the carbon content on the surface of alumina indicated that the carbon deposited on the surface of alumina affected directly the formation of inductance.

The voltage in the output of Example 4 was recorded after applying a single pulse to alumina beads as shown in FIG. 1. The appearance of the damping wave indicated the formation of RLC circuit with trace amount of inductance.

### EXAMPLES 7-10

### Use of Propane as Hydrocarbon

Carbon was deposited according to Example 1 except applying propane as hydrocarbon, calcination temperature and carbonization time. The inductance, resistance and capacitance were measured.

### EXAMPLES 11-12

### Use of Aniline as Hydrocarbon

Carbon was deposited according to Example 1 except applying aniline as hydrocarbon, and carbonization time.

TABLE 1

| | | | Carbon | | | | | |
|---|---|---|---|---|---|---|---|---|
| | | | content | | | | | |
| | | Time | (g_{carbon}/ | Deposition | Calcinating | Resistance | Capacitance | Inductance |
| Example | hydrocarbon | (hr) | gₐₗᵤₘᵢₙₐ) | Temp (° C.) | Temp (° C.) | (ohm) | (pF) | (nH) |
| 1 | Methane | 6 | 0.292 | 1000 | 900 | 3.1 | Trace* | 1.4 |
| 2 | Methane | 3 | 0.228 | 1000 | 900 | 4.6 | Trace | 1.2 |
| 3 | Methane | 2 | 0.121 | 1000 | 900 | 10.0 | Trace | 1.0 |
| 4 | Methane | 1 | 0.086 | 1000 | 900 | 1.4 × 10⁴ | 1.6 | Trace |
| 5 | Methane | 0.7 | 0.045 | 1000 | 900 | 2.5 × 10⁴ | 2.9 | Trace |
| 6 | Methane | 0.4 | 0.030 | 1000 | 900 | 3.5 × 10⁴ | 3.8 | Trace |
| 7 | propane | 6 | 0.047 | 550 | 330 | 4.5 × 10⁴ | 0.4 | Trace |
| 8 | propane | 3 | 0.176 | 580 | 330 | 6.8 × 10⁴ | 0.4 | Trace |
| 9 | propane | 2 | 0.071 | 550 | 330 | 1.7 × 10⁴ | 0.2 | Trace |
| 10 | propane | 1 | 0.083 | 550 | 900 | 96 | Trace | Trace |
| 11 | aniline | 1 | 0.198 | 1000 | 900 | 3.2 | Trace | 2.8 |
| 12 | aniline | 2 | 0.357 | 1000 | 900 | 1.4 | Trace | 1.2 |

*trace below the detectable boundary of the detector used

### EXAMPLE 13

### Two-Dimensional Circuit

A circuit with 1 mm of width was prepared by photolithography on the surface of two-dimensional alumina and its surface was sensitized by Ni ion and Fe ion separately. Carbon was then deposited thereon according to Example 1 by employing methane as hydrocarbon. Multi wall carbon nanotube was produced on the Ni surface and amorphous fiber was produced on the Fe surface.

### EXAMPLE 14

### Three-Dimensional Circuit

A circuit with 1 mm of width was prepared by photolithography orthogonal to the two-dimensional carbon surface prepared from Example 13 and its surface was sensitized by Ni ion and Fe ion separately. Carbon was then deposited thereon according to Example 1 by employing methane as hydrocarbon. The thickness of each circuit was proportional to the chemical vapor deposition time and after 6 hrs, the carbon layer having a thickness of 10-300 micron was formed.

As described above, RLC circuits employing carbon nanotubes of the present invention provide much smaller inductance than that of ferrite coil but generates enough inductance. Thus, it allows to design RLC microchips and three-dimensional as well as two dimensional RLC circuits to be applied in the field of communication circuits, semiconductor circuits and the like.

What is claimed is:

1. Carbon nanotube RLC (Resistance, Inductance, and Capacitance) circuits prepared by chemical vapor deposition of carbon on the surface of an inorganic substrate.

2. Carbon nanotube RLC circuits according to claim 1, wherein another character of carbon nanotube is deposited two-dimensionally on the surface of said deposited carbon nanotube.

3. Carbon nanotube RLC circuits according to claim 2, wherein another character of carbon nanotube is deposited three-dimensionally on the surface of the two-dimensionally deposited carbon nanotube.

4. Carbon nanotube RLC circuits according to claim 1, wherein said inorganic substrate has acid sites or at least one selected from the group consisting of Ni, Fe, Co, Cu, Mn, Cr, Mo, W, Ru, Rh, Pd, Pt and C on the surface.

5. Carbon nanotube RLC circuits according to claim 1, wherein said inorganic substrate is at least one selected from the group consisting of alumina, silica, aluminosilicate, laminated compound, zeolite, mesoporous material, yttrium stabilized zirconia, zirconia, Fe₂O₃, TiO₂, NbₙOₓ, carbon and Mn₂O₃.

6. Carbon nanotube RLC circuits according to claim 1, wherein carbon used for said chemical vapor deposition is hydrocarbons having C₁-C₂₄ and capable of being vaporized.

7. Carbon nanotube RLC circuits according to claim 6, wherein said hydrocarbon may contain at least one selected from the group consisting of S, N, P, B, Al and Ga.

8. Carbon nanotube RLC circuits according to claim 6, wherein besides said hydrocarbon, a compound comprising at least one selected from the group consisting of S, N, P, B, Al and Ga is additionally used.
